(19) United States
(12) Patent Application Publication
(10) Pub. No.: US 2025/0055238 A1
(43) Pub. Date: Feb. 13, 2025

(54) COAXIAL CABLE CONNECTOR

(71) Applicant: Japan Aviation Electronics Industry, Ltd., Tokyo (JP)

(72) Inventors: Takeharu NAITO, Tokyo (JP); Tomoyuki UCHIDA, Tokyo (JP); Kazuki ISHII, Tokyo (JP); Junji OOSAKA, Tokyo (JP); Ryou KATOU, Tokyo (JP)

(21) Appl. No.: 18/796,907

(22) Filed: Aug. 7, 2024

(30) Foreign Application Priority Data
Aug. 8, 2023 (JP) 2023-129028

(51) Int. Cl. H01R 24/44; H01R 9/05

(52) U.S. Cl. CPC H01R 24/44; H01R 9/0512

(57) ABSTRACT

Provided is a coaxial cable connector with improved impedance matching. A relay connector device, which is an example of a coaxial cable connector, is a relay connector device including a connector that relays a cable. The connector includes a contact containing a conductor, an internal housing containing an insulator and supporting the contact, and an impedance adjuster having a part incorporated into the internal housing and containing the conductor. The impedance adjuster covers an exposed part of a core wire of the cable connected to the contact, which is exposed from the internal housing.

### INCORPORATION BY REFERENCE

This application is based upon and claims the benefit of priority from Japanese patent application No. 2023-129028, filed on Aug. 8, 2023, the disclosure of which is incorporated herein in its entirety by reference.

### BACKGROUND

The present disclosure relates to a coaxial cable connector.

In an on-vehicle coaxial connector, it is essential to adjust impedance to improve transmission characteristics in terms of performance enhancement. In a relay connector device that relays a cable, it is important to control an increase in impedance of a spatial layer in a crimp part between a contact and a copper wire.

### SUMMARY

In a relay connector device as disclosed in Japanese Unexamined Patent Application Publication No. 2020-107567, for example, a spatial layer is formed in a crimp part between a contact and a copper wire. Such a spatial layer containing air causes an increase in impedance and deterioration of matching with design impedance.

The present disclosure has been accomplished to solve the above problem, and an object of the present disclosure is thus to provide a coaxial cable connector with improved impedance matching.

According to an aspect of the present disclosure, a coaxial cable connector is a coaxial cable connector including a connector for relaying a cable, the connector including a contact containing a conductor, an insulator body containing an insulator and supporting the contact, and an impedance adjuster having a part incorporated into the insulator body and containing the conductor, wherein the impedance adjuster covers an exposed part of a core wire of the cable connected to the contact, the exposed part being exposed from the insulator body.

In the above-described coaxial cable connector, the connector may further include a GND shell containing the conductor, the contact, the insulator body, and the impedance adjuster may be disposed inside the GND shell, and the impedance adjuster is disposed in a spatial layer formed between the exposed part and the GND shell.

In the above-described coaxial cable connector, the impedance adjuster may have a tube shape with a center axis located at the contact and the core wire.

In the above-described coaxial cable connector, the cable may include the core wire containing the conductor, a coating having a part covering the core wire and containing the insulator, a shield having a part covering the coating and containing the conductor, and an outside cover having a part covering the shield and containing the insulator, and the impedance adjuster may cover an end of the coating.

In the above-described coaxial cable connector, the impedance adjuster may be incorporated into the insulator body by insert molding.

In the above-described coaxial cable connector, the impedance adjuster may be incorporated into the insulator body by being press-fit to the insulator body.

In the above-described coaxial cable connector, the impedance adjuster may be electrically connected to the GND shell.

In the above-described coaxial cable connector, the impedance adjuster may be electrically isolated from the GND shell, the contact, and the core wire.

According to an aspect of the present disclosure, a coaxial cable connector is a coaxial cable connector including a first connector and a second connector for relaying a first cable and a second cable, wherein the first connector includes a first contact containing a conductor and including a projection at one end, a first insulator body containing an insulator and supporting the first contact, and a first impedance adjuster having a part incorporated into the first insulator body and containing the conductor, the first impedance adjuster covers an exposed part of a first core wire of the first cable connected to another end of the first contact, the exposed part being exposed from the first insulator body, the second connector includes a second contact containing the conductor and including a recess at one end, a second insulator body containing the insulator and supporting the second contact, and a second impedance adjuster having a part incorporated into the second insulator body and containing the conductor, the second impedance adjuster covers an exposed part of a second core wire of the second cable connected to another end of the second contact, the exposed part being exposed from the second insulator body, and the projection of the first contact mates with the recess of the second contact.

According to the present disclosure, there is provided a coaxial cable connector with improved impedance matching.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a sectional view illustrating a relay connector device according to a comparative example;

FIG. 2 is a perspective view illustrating a connector in the relay connector device according to the comparative example;

FIG. 3 is a perspective view illustrating a connector in the relay connector device according to the comparative example;

FIG. 4 is an exploded perspective view illustrating each member constituting the connector in the relay connector device according to the comparative example;

FIG. 5 is a perspective view illustrating an internal housing in the relay connector device according to the comparative example;

FIG. 6 is an exploded perspective view illustrating each member constituting the connector in the relay connector device according to the comparative example;

FIG. 7 is a perspective view illustrating an internal housing in the relay connector device according to the comparative example;

FIG. 8 is a sectional view illustrating the operation of connecting connectors in the relay connector device according to the comparative example;

FIG. 9 is a schematic view illustrating a related relay connector device;

FIG. 10 is a schematic view illustrating a related relay connector device;

FIG. 11 is a sectional view illustrating a relay connector device according to a first embodiment;

FIG. 12 is a perspective view illustrating a connector in the relay connector device according to the first embodiment;

FIG. 13 is a perspective view illustrating a connector in the relay connector device according to the first embodiment;

FIG. 14 is an exploded perspective view illustrating each member constituting the connector in the relay connector device according to the first embodiment;

FIG. 15 is a perspective view illustrating an internal housing and an impedance adjuster in the relay connector device according to the first embodiment;

FIG. 16 is an exploded perspective view illustrating each member constituting the connector in the relay connector device according to the first embodiment;

FIG. 17 is a perspective view illustrating the internal housing and the impedance adjuster in the relay connector device according to the first embodiment;

FIG. 18 is a sectional view illustrating the operation of connecting connectors in the relay connector device according to the first embodiment; and

FIG. 19 is a graph illustrating impedance in the relay connector device according to the first embodiment, where the horizontal axis indicates time and the vertical axis indicates impedance.

### DESCRIPTION OF EMBODIMENTS

A specific structure of the present disclosure will be described hereinbelow with reference to the drawings. The description provided hereinbelow merely illustrates a preferred embodiment of the present disclosure, and the present disclosure is not limited to the below-described embodiment. In the following description, the identical reference symbols denote substantially identical elements. For clarity of the drawings, some reference symbols and hatching are omitted.

A coaxial cable connector according to this embodiment will be described. In the following, a relay connector device that relays a cable will be described as an example of the coaxial cable connector according to this embodiment. Note that the coaxial cable connector according to this embodiment is not limited to the relay connector device, and it may include another connector device such as a coaxial connector device where a cable mates with a board as long as it is configured to connect a coaxial cable. Prior to describing a relay connector device according to a first embodiment, a relay connector device according to a comparative example will be described for comparison. This will clarify the features of the relay connector device according to the first embodiment.

### Comparative Example

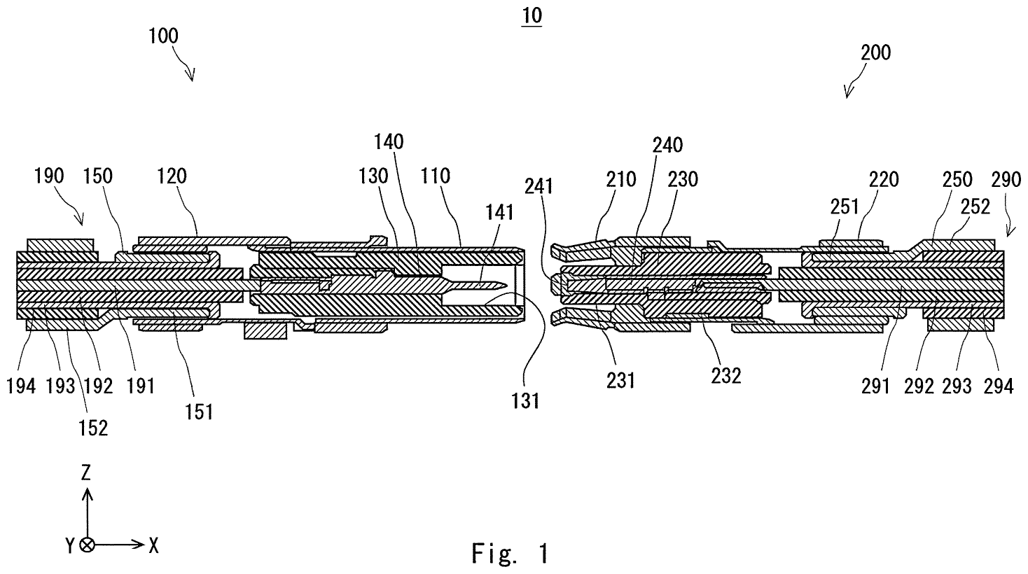

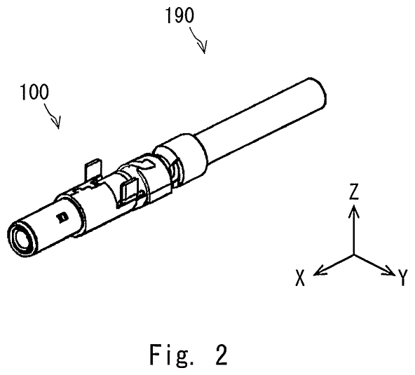

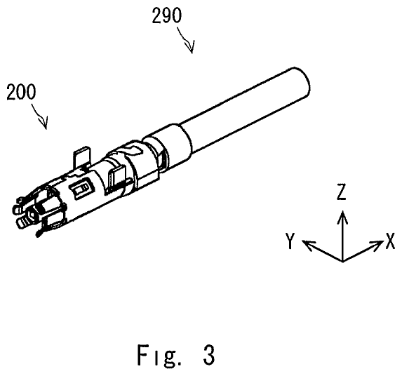

The relay connector device according to the comparative example is described hereinafter. FIG. 1 is a sectional view illustrating a relay connector device 10 according to a comparative example. FIG. 2 is a perspective view illustrating a connector 100 in the relay connector device 10 according to the comparative example. FIG. 3 is a perspective view illustrating a connector 200 in the relay connector device 10 according to the comparative example. In FIGS. 1 to 3, an external housing is omitted. Note that the relay connector device 10 may be used in separation from the external housing.

As shown in FIGS. 1 to 3, the relay connector device 10 according to the comparative example includes the connector 100 and the connector 200. The connector 100 is the connector 100 on the male side, for example, and the connector 200 is the connector 200 on the female side, for example. The connector 100 is connected to an end of a cable 190. The connector 200 is connected to an end of a cable 290. The connector 100 is connected to the connector 200. The relay connector device 10 thereby relays the cable 190 and the cable 290.

For the convenience of description of the relay connector device 10 and a relay connector device 20, which is described later, the xyz-orthogonal coordinate axis system is used. For example, an axial direction that is coaxial with the relay connector device 10 or the like is referred to as x axis direction. A direction where the connector 100 on the male side is headed to the connector 200 on the female side when connecting the connector 100 and the connector 200 is referred to as +x direction. Two directions orthogonal to the x axis are referred to as y axis direction and z axis direction.

### Male-Side Connector

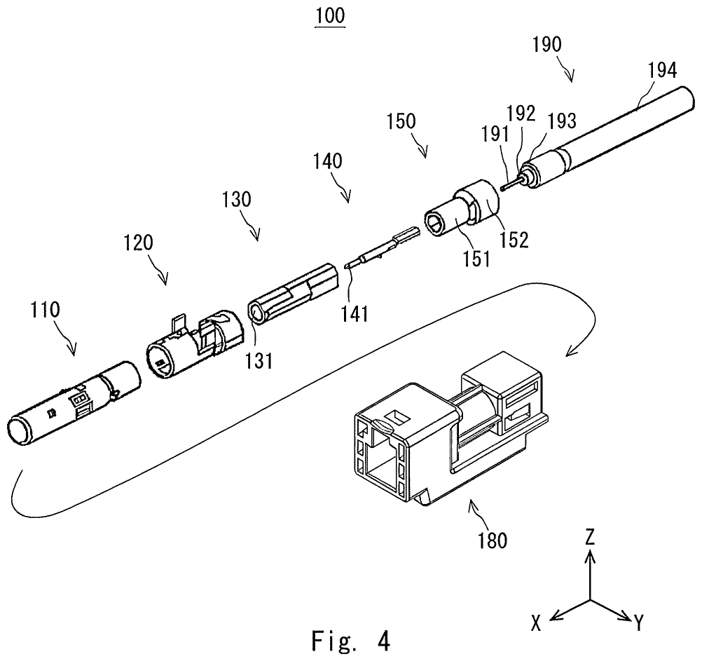

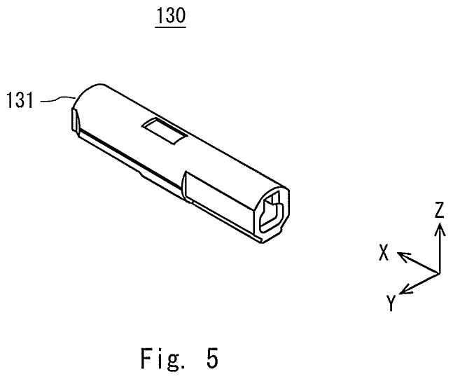

The connector 100 on the male side is described hereinafter. FIG. 4 is an exploded perspective view illustrating each member constituting the connector 100 in the relay connector device 10 according to the comparative example. FIG. 5 is a perspective view illustrating an internal housing 130 in the relay connector device 10 according to the comparative example. As shown in FIGS. 1 to 2 and FIGS. 4 to 5, the connector 100 includes a GND shell 110, a GND shell 120, an internal housing 130, a contact 140, a sleeve 150, and an external housing 180. Each member is described hereinbelow.

### GND Shell

The GND shell 110 and the GND shell 120 contain a conductor as a material. For example, the GND shell 110 and the GND shell 120 contain a metal as a material. Note that the GND shell 110 and the GND shell 120 may contain a material other than a metal as long as it contains a conductor. The GND shell 110 and the GND shell 120 are electrically connected to a ground potential.

The GND shell 110 and the GND shell 120 have a tube shape. For example, the GND shell 110 and the GND shell 120 have a cylindrical shape. The GND shell 110 and the GND shell 120 are disposed in such a way that their center axes are in the x axis direction. The center axes of the GND shell 110 and the GND shell 120 coincide with each other. The GND shell 110 is disposed on the +x axis direction side of the GND shell 120. The GND shell 110 may partly overlap the GND shell 120. For example, a part of the GND shell 110 on the −x axis direction side overlaps a part of the GND shell 120 on the +x axis direction side. The GND shell 110 and the GND shell 120 integrally have a cylindrical shape.

The internal housing 130 and the contact 140 are disposed inside the GND shell 110 and the GND shell 120. The sleeve 150 and a part of the cable 190 may be disposed inside the GND shell 120. The internal housing 130 may be press-fit to the inside of the GND shell 110.

An end of the GND shell 110 on the +x axis direction side is disposed in close proximity to an end of the internal housing 130 on the +x axis direction side. The position on the x axis of the end of the GND shell 110 on the +x axis direction side may coincide with that of the end of the internal housing 130 on the +x axis direction side. An end of the GND shell 120 on the −x axis direction side is located above an outside cover 194 of the cable 190. The end of the GND shell 120 on the −x axis direction side is disposed in close proximity to an end of the sleeve 150 on the −x axis direction side. For example, the position on the x axis of the end of the GND shell 120 on the −x axis direction side may coincide with that of the end of the sleeve 150 on the −x axis direction side.

### Internal Housing

The internal housing 130 contains an insulator as a material. The internal housing 130 is also called an insulator body. For example, the internal housing 130 contains a resin as a material. Note that the internal housing 130 may contain a material other than a resin as long as it contains an insulator.

The internal housing 130 has a tube shape. For example, the internal housing 130 has a cylindrical shape. The internal housing 130 is disposed in such a way that its center axis is in the x axis direction. The internal housing 130 is disposed inside the GND shell 110. The contact 140 is disposed inside the internal housing 130. Thus, the internal housing 130 supports the contact 140. The contact 140 disposed inside the internal housing 130 may be press-fit into the internal housing 130.

The internal housing 130 has a recess 131 in its end surface on the +x axis direction side. An end of the contact 140 on the +x axis direction side projects from a bottom surface of the recess 131. One end of the contact 140 on the +x axis direction side includes a projection 141. A side wall of the recess 131 of the internal housing 130 surrounds the end of the contact 140 on the +x axis direction side.

An end of the internal housing 130 on the −x axis direction side is located in close proximity to an end of the contact 140 on the −x axis direction side. For example, the position on the x axis of the end of the internal housing 130 on the −x axis direction side may coincide with that of another end of the contact 140 on the −x axis direction side. A core wire 191 of the cable 190 is connected to the end of the contact 140 on the −x axis direction side. A connection part between the contact 140 and the core wire 191 of the cable 190 may be disposed inside the internal housing 130.

### Contact

The contact 140 contains a conductor as a material. For example, the contact 140 contains a metal as a material. Note that the contact 140 may contain a material other than a metal as long as it contains a conductor. The contact 140 serves as a transmission path of a high-frequency signal, for example.

The contact 140 has a bar shape. The contact 140 is disposed in such a way that its center axis is in the x axis direction. The contact 140 has the projection 141 at one end on the +x axis direction side. The contact 140 is disposed inside the internal housing 130. The other end of the contact 140 on the −x axis direction side is connected to the core wire 191 of the cable 190. The projection 141 at one end of the contact 140 on the +x axis direction side is connected to a contact 240 of the connector 200 on the female side. The projection 141 of the contact 140 has a projecting shape to mate with a recess 241 of the contact 240.

### Sleeve

The sleeve 150 contains a conductor as a material. For example, the sleeve 150 contains a metal as a material. Note that the sleeve 150 may contain a material other than a metal as long as it contains a conductor.

The sleeve 150 has a tube shape. For example, the sleeve 150 has a cylindrical shape. The sleeve 150 is disposed in such a way that its center axis is in the x axis direction. The sleeve 150 includes a first part 151 in cylindrical shape and a second part 152 in cylindrical shape. The first part 151 and the second part 152 are connected in parallel in the x axis direction. The first part 151 is disposed on the +x axis direction side of the second part 152. The outside diameter of the first part 151 is smaller than the outside diameter of the second part 152. The inside diameter of the first part 151 is smaller than the inside diameter of the second part 152.

The first part 151 is disposed inside the GND shell 120. The first part 151 covers a shield 193 that is exposed from an end of the outside cover 194 of the cable 190. The second part 152 covers the outside cover 194 of the cable 190. A connection part between the first part 151 and the second part 152 is located in close proximity to an end of the outside cover 194 on the +x axis direction side.

### External Housing

The external housing 180 contains an insulator as a material. For example, the external housing 180 contains a resin as a material. Note that the external housing 180 may contain a material other than a resin as long as it contains an insulator.

The external housing 180 has a tube shape. For example, the external housing 180 has a square tube shape. The external housing 180 is disposed in such a way that its center axis is in the x axis direction. An assembly of the GND shell 110, the GND shell 120, the internal housing 130, the contact 140, and the sleeve 150 is mounted inside the external housing 180.

### Cable

The structure of the cable 190 is described hereinafter. The cable 190 extends in one direction and has flexibility. The cable 190 includes the core wire 191, a coating 192, a shield 193, and the outside cover 194. The core wire 191, the coating 192, the shield 193, and the outside cover 194 are disposed in concentric layers. Those members are stacked concentrically with the core wire 191 at the center. When the cable 190 extends in the x axis direction, those members are stacked concentrically with their center axes in the x axis direction. The coating 192 covers a side surface of the core wire 191. The shield 193 covers a side surface of the coating 192. The outside cover 194 covers a side surface of the shield 193.

The core wire 191 contains a conductor as a material. The core wire 191 has a linear shape. The core wire 191 may contain a copper wire, for example. Note that the core wire 191 may contain a material other than a copper wire as long as it contains a linear conductor. A part of the core wire 191 on the +x axis direction side projects from an end of the coating 192 on the +x axis direction side.

The coating 192 contains an insulator as a material. For example, the coating 192 contains a resin as a material. Note that the coating 192 may contain a material other than a resin as long as it contains an insulator. The coating 192 has a tube shape. The coating 192 has a part that covers the side surface of the core wire 191. The end of the coating 192 on the +x axis direction side may be a cut surface. A part of the coating 192 on the +x axis direction side may be exposed from an end of the shield 193 on the +x axis direction side.

The shield 193 contains a conductor as a material. For example, the shield 193 may contain a metal. Note that the shield 193 may contain a material other than a metal as long as it contains a conductor. The shield 193 has a tube shape. The shield 193 has a part that covers the side surface of the coating 192. The end of the shield 193 on the +x axis direction side is folded to the −x axis direction side. To be specific, the end of the shield 193 on the +x axis direction side is folded to the −x axis direction side along an edge of the first part 151 of the sleeve 150 on the +x axis direction side. The end of the folded shield 193 on the +x axis direction side is connected to an inner surface of the GND shell 120. Thus, the shield 193 is electrically connected to the ground potential. A part of the shield 193 on the +x axis direction side may be exposed from an end of the outside cover 194 on the +x axis direction side.

The outside cover 194 contains an insulator as a material. For example, the outside cover 194 may contain a resin. The outside cover 194 may contain a material other than a resin as long as it contains an insulator. The outside cover 194 has a tube shape. The outside cover 194 has a part that covers the side surface of the shield 193. The end of the outside cover 194 on the +x axis direction side may be a cut surface. A part of the outside cover 194 on the +x axis direction side may be covered with at least any one of the sleeve 150 and the GND shell 120.

### Female-Side Connector

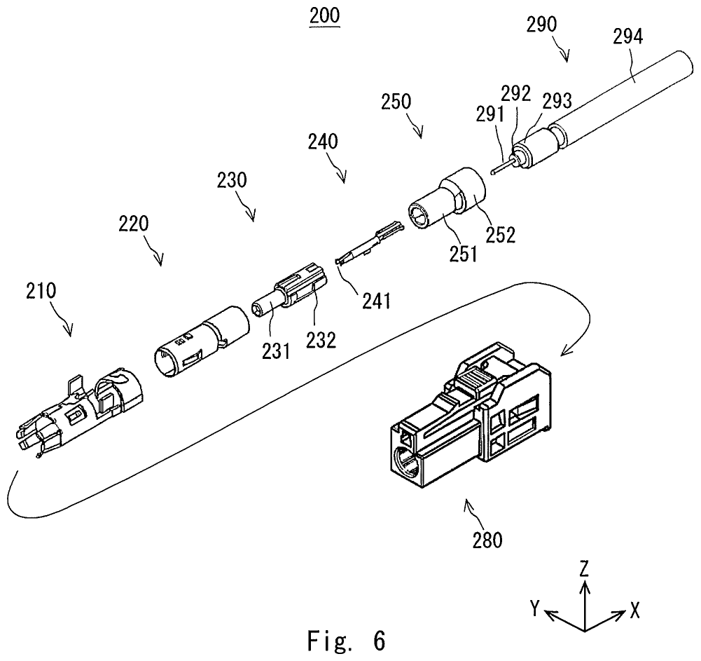

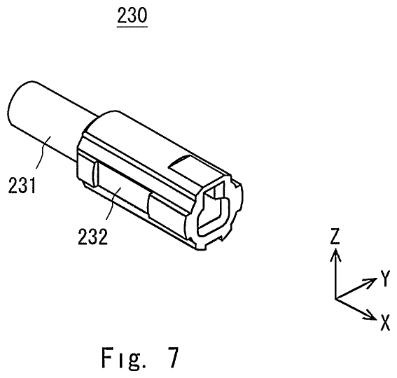

The connector 200 on the female side is described hereinafter. FIG. 6 is an exploded perspective view illustrating each member constituting the connector 200 in the relay connector device 10 according to the comparative example. FIG. 7 is a perspective view illustrating an internal housing 230 in the relay connector device 10 according to the comparative example. As shown in FIG. 1, FIG. 3, and FIGS. 6 to 7, the connector 200 includes a GND shell 210, a GND shell 220, an internal housing 230, a contact 240, a sleeve 250, and an external housing 280.

In the case of the connector 100, the cable 190 is located on the −x axis direction side of the connector 100, whereas in the case of the connector 200, the cable 290 is located on the +x axis direction side of the connector 200. Otherwise, the basic structures and functions of the GND shell 210, the GND shell 220, the internal housing 230, the contact 240, the sleeve 250, and the external housing 280 of the connector 200 are the same as the structures and functions of the GND shell 110, the GND shell 120, the internal housing 130, the contact 140, the sleeve 150, and the external housing 180 of the connector 100, respectively.

### GND Shell

The GND shell 210 is disposed on the −x axis direction side of the GND shell 220. The internal housing 230 and the contact 240 are disposed inside the GND shell 210 and the GND shell 220. The sleeve 250 and the cable 290 may be disposed inside the GND shell 220. The internal housing 230 may be press-fit to the inside of the GND shell 210.

An end of the GND shell 210 on the −x axis direction side is disposed in close proximity to an end of the internal housing 230 on the −x axis direction side. The position on the x axis of the end of the GND shell 210 on the −x axis direction side may coincide with that of the end of the internal housing 230 on the −x axis direction side. An end of the GND shell 220 on the +x axis direction side is located above an outside cover 294 of the cable 290. The end of the GND shell 220 on the +x axis direction side is disposed in close proximity to an end of the sleeve 250 on the +x axis direction side. For example, the position on the x axis of the end of the GND shell 220 on the +x axis direction side may coincide with that of the end of the sleeve 250 on the +x axis direction side.

### Internal Housing

The internal housing 230 is disposed inside the GND shell 210. The contact 240 is disposed inside the internal housing 230. Thus, the contact 240 is disposed inside the GND shell 210. The internal housing 230 supports the contact 240.

The internal housing 230 includes a first part 231 and a second part 232. The first part 231 is disposed on the −x axis direction side of the second part 232. The first part 231 and the second part 232 have a cylindrical shape whose center axis coincides with the center axis of the internal housing 230. The outside diameter of the first part 231 is smaller than the outside diameter of the second part 232. The first part 231 mates with the recess 131 of the internal housing 130 of the connector 100. When the first part 231 mates with the recess 131, the projection 141 of the contact 140 of the connector 100 mates with the recess 241 of the contact 240 of the connector 200.

An end of the internal housing 230 on the −x axis direction side is an end surface of the first part 231 on the −x axis direction side. The end of the internal housing 230 on the −x axis direction side is disposed in close proximity to an end of the GND shell 210 on the −x axis direction side. For example, the position on the x axis of the end of the internal housing 230 on the −x axis direction side may coincide with that of the end of the GND shell 210 on the −x axis direction side. The recess 241 on the −x axis direction side of the contact 240 is disposed inside the first part 231.

An end of the internal housing 230 on the +x axis direction side is disposed in close proximity to an end of the contact 240 on the +x axis direction side. For example, the position on the x axis of the end of the internal housing 230 on the +x axis direction side may coincide with that of another end of the contact 240 on the +x axis direction side. A core wire 291 of the cable 290 is connected to the end of the contact 240 on the +x axis direction side. A connection part between the contact 240 and the core wire 291 of the cable 290 may be disposed inside the internal housing 230.

### Contact

The contact 240 has the recess 241 at one end on the −x axis direction side. The contact 240 is disposed inside the internal housing 230. An end of the contact 240 on the +x axis direction side is connected to the core wire 291 of the cable 290. The projection 141 of the contact 140 mates with the recess 241 of the contact 240.

### Sleeve

The sleeve 250 includes a first part 251 in cylindrical shape and a second part 252 in cylindrical shape. The first part 251 is disposed on the −x axis direction side of the second part 252. The outside diameter of the first part 251 is smaller than the outside diameter of the second part 252. The inside diameter of the first part 251 is smaller than the inside diameter of the second part 252.

The first part 251 is disposed inside the GND shell 220. The first part 251 covers a shield 293 that is exposed from an end of the outside cover 294 of the cable 290. The second part 252 covers the outside cover 294 of the cable 290. A connection part between the first part 251 and the second part 252 is thus located in close proximity to an end of the outside cover 294.

### Cable

The cable 290 includes the core wire 291, a coating 292, the shield 293, and the outside cover 294. The structures and functions of the core wire 291, the coating 292, the shield 293, and the outside cover 294 in the cable 290 are the same as the structures and functions of the core wire 191, the coating 192, the shield 193, and the outside cover 194 in the cable 190, respectively. Note that, however, the direction in which the core wire 291 connects to the contact 240, the direction of the end surface of the coating 292 having the cut surface, the direction of the end of the shield 293 and the direction in which it is folded, the direction of the end surface of the outside cover 294 and the like are opposite to those in the cable 190.

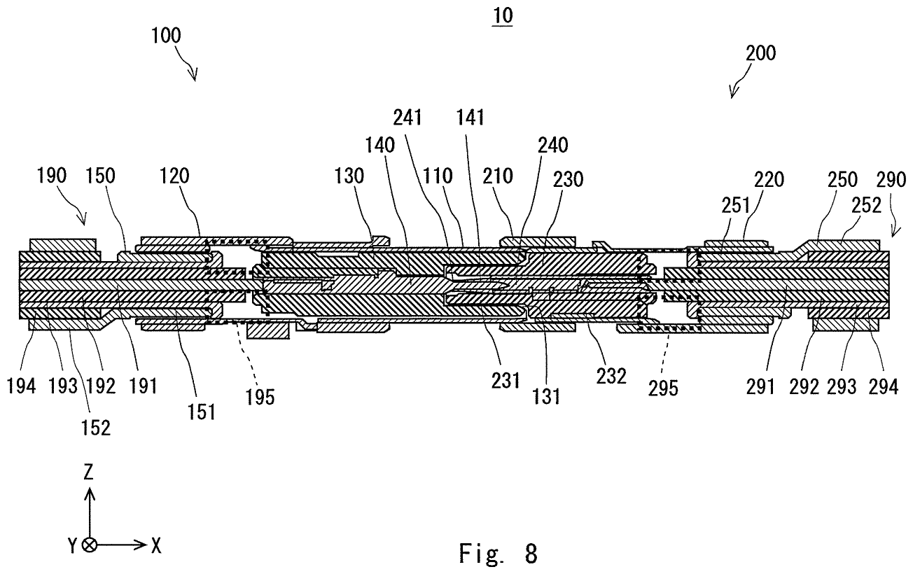

The operation of connection of the relay connector device 10 according to the comparative example is described hereinafter. FIG. 8 is a sectional view illustrating the operation of connecting the connectors 100 and 200 in the relay connector device according to the comparative example. As shown in FIGS. 1 and 8, in the relay connector device 10 according to the comparative example, the connector 100 and the connector 200 are opposed to each other. Then, the projection 141 of the contact 140 mates with the recess 241 of the contact 240. A transmission path of a high-frequency signal is thereby formed between the contact 140 and the contact 240. At the same time, the first part 231 of the internal housing 230 may mate with the recess 131 of the internal housing 130. Further, the GND shell 110 and the GND shell 210 come into contact with each other. A shield that covers the transmission path of a high-frequency signal is thereby formed.

### Problem in Comparative Example

In the relay connector device 10, a spatial layer 195 is formed between the core wire 191 and the GND shells 110 and 120 in a region from a connection part between the other end of the contact 140 on the −x axis direction side and the end of the core wire 191 on the +x axis direction side to the end of the coating 192 of the cable 190 on the +x axis direction side. To be specific, the spatial layer 195 is formed between an exposed part of the core wire 191 connected to the contact 140, which is exposed from the internal housing 130 and the coating 192, and the GND shells 110 and 120.

Further, a spatial layer 295 is formed between the core wire 291 and the GND shells 210 and 220 in a region from a connection part between the other end of the contact 240 on the +x axis direction side and the end of the core wire 291 on the −x axis direction side to the end of the coating 292 of the cable 290 on the −x axis direction side. To be specific, the spatial layer 295 is formed between an exposed part of the core wire 291 connected to the contact 240, which is exposed from the internal housing 230 and the coating 292, and the GND shells 210 and 220.

As described above, the spatial layers 195 and 295 that contain air are formed near a connection part of the contacts 140 and 240. Due to the existence of the spatial layers 195 and 295, the impedance of the relay connector device 10 increases. This makes it difficult to improve the matching with design impedance. One approach to reduce the impedance near the spatial layers 195 and 295 is deforming the GND shells 120 and 220 to bring them nearer to the core wires 191 and 291, for example.

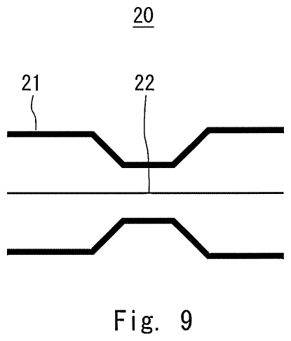

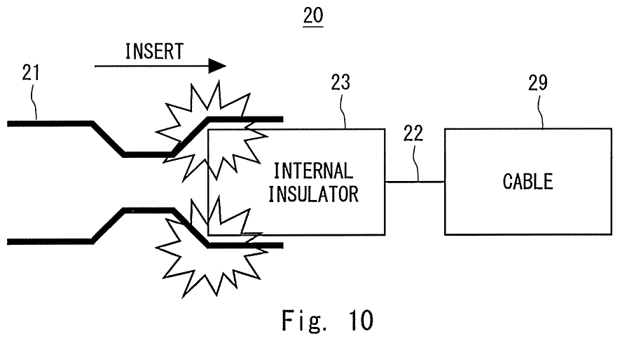

FIGS. 9 and 10 are schematic views illustrating a related relay connector device 20. As shown in FIG. 9, in the related relay connector device 20, a part of the cross section of a GND shell 21 has a recessed shape. The GND shell 21 thereby comes closer to a core wire 22. This allows improving the impedance matching. However, as shown in FIG. 10, if the GND shell 21 has a recessed shape, when an internal insulator 23 is inserted into the GND shell 21 for assembly, the internal insulator 23 and the recess of the GND shell 21 come into contact, which makes it difficult to assembly the related relay connector device 20. This hinders the core wire 22 disposed between the internal insulator 23 and a cable 29 from coming closer to the GND shell 21. The improvement of the impedance matching is thereby not achieved in the related relay connector device 20.

### First Embodiment

A relay connector device 30 according to the first embodiment is described hereinafter. This embodiment does not adopt the approach that brings the GND shell 110 or the like close to the core wires 191 and 291 to reduce the impedance of the core wires 191 and 291 near the spatial layers 195 and 295. Alternatively, this embodiment incorporates an impedance adjuster into the internal housings 130 and 230. The impedance of the relay connector device is thereby adjusted.

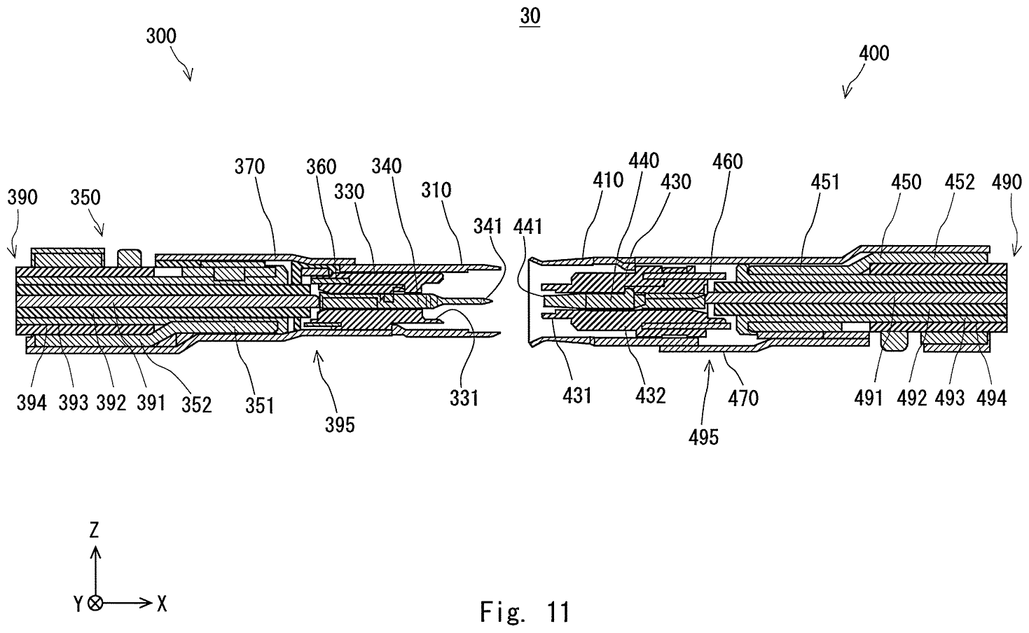

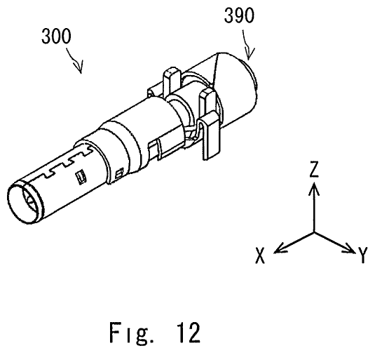

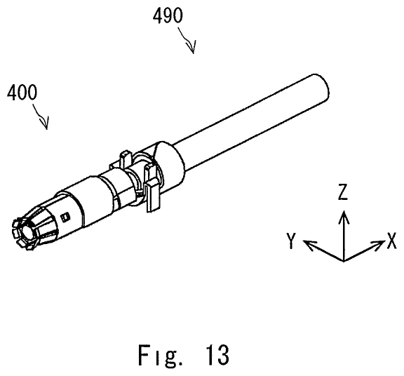

FIG. 11 is a sectional view illustrating the relay connector device 30 according to the first embodiment. FIG. 12 is a perspective view illustrating a connector 300 in the relay connector device 30 according to the first embodiment. FIG. 13 is a perspective view illustrating a connector 400 in the relay connector device 30 according to the first embodiment. In FIGS. 11 to 13, an external housing is omitted. Note that the relay connector device 30 may be used in separation from the external housing.

As shown in FIGS. 11 to 13, the relay connector device 30 according to this embodiment includes the connector 300 and the connector 400. The connector 300 is the connector 300 on the male side, and the connector 400 is the connector 400 on the female side, for example. The connector 300 is connected to an end of a cable 390. The connector 400 is connected to an end of a cable 490. The connector 300 is connected to the connector 400. The relay connector device 30 thereby relays the cable 390 and the cable 490.

### Male-Side Connector

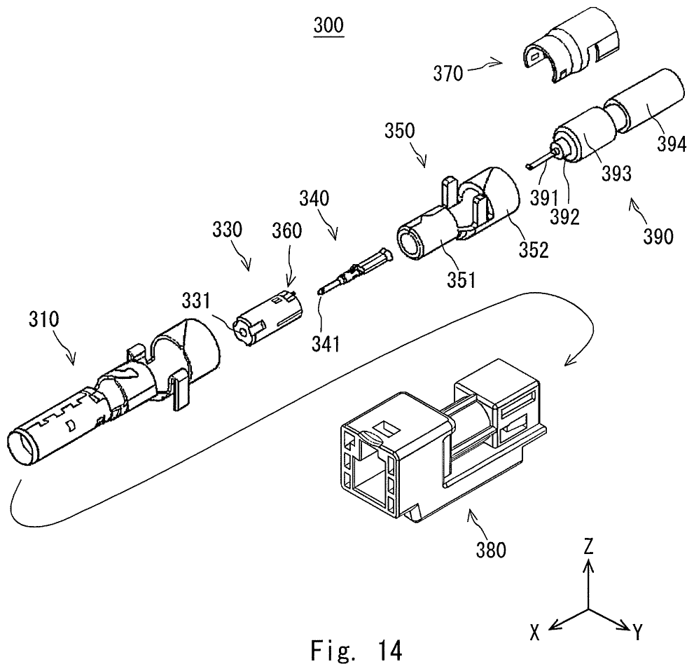

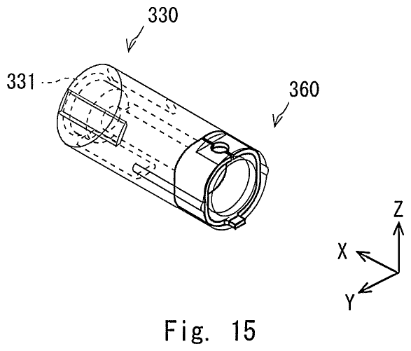

FIG. 14 is an exploded perspective view illustrating each member constituting the connector 300 in the relay connector device 30 according to the first embodiment. FIG. 15 is a perspective view illustrating an internal housing 330 and an impedance adjuster 360 in the relay connector device 30 according to the first embodiment. In FIG. 15, the internal housing 330 is shown transparent. As shown in FIGS. 11 to 12 and FIGS. 14 to 15, the connector 300 includes a GND shell 310, the internal housing 330, a contact 340, a sleeve 350, the impedance adjuster 360, an EMI shell 370, and an external housing 380. The basic structures and functions of the GND shell 310, the internal housing 330, the contact 340, the sleeve 350, and the external housing 380 in the connector 300 are the same as the structures and functions of the GND shells 110 and 120, the internal housing 130, the contact 140, the sleeve 150, and the external housing 180 in the connector 100, respectively.

### GND Shell

The GND shell 310 corresponds to an integrated combination of the GND shells 110 and 120 in the connector 100. The internal housing 330, the contact 340, and the impedance adjuster 360 are disposed inside the GND shell 310. Further, the sleeve 350 and a part of the cable 390 are disposed inside the GND shell 310. The internal housing 330 may be press-fit to the inside of the GND shell 310.

An end of the GND shell 310 on the +x axis direction side is disposed in close proximity to an end of the internal housing 330 on the +x axis direction side. On the other hand, an end of the GND shell 310 on the −x axis direction side is located above an outside cover 394 of the cable 390. The position on the x axis of the end of the GND shell 310 on the −x axis direction side may coincide with that of an end of the sleeve 350 on the −x axis direction side.

### Internal Housing

As shown in FIG. 15, the internal housing 330 incorporates a part of the impedance adjuster 360. For example, a part of the internal housing 330 on the −x axis direction side incorporates a part of the impedance adjuster 360 on the +x axis direction side.

The internal housing 330 is disposed inside the GND shell 310. The contact 340 is disposed inside the internal housing 330. The internal housing 330 supports the contact 340. The internal housing 330 has a recess 331 in its end surface on the +x axis direction side. One end of the contact 340 on the +x axis direction side projects from a bottom surface of the recess 331. One end of the contact 340 on the +x axis direction side includes a projection 341. A side wall of the recess 331 of the internal housing 330 surrounds the projection 341 of the contact 340 on the +x axis direction side.

An end of the internal housing 330 on the −x axis direction side is disposed in close proximity to an end of the contact 340 on the −x axis direction side. The position on the x axis of the end of the internal housing 330 on the −x axis direction side may coincide with that of another end of the contact 340 on the −x axis direction side. A core wire 391 of the cable 390 is connected to the end of the contact 340 on the −x axis direction side. A connection part between the contact 340 and the core wire 391 may be disposed inside the internal housing 330.

### Contact

The contact 340 has the projection 341 at one end on the +x axis direction side. One end of the contact 340 on the +x axis direction side is connected to a contact 440 of the connector 400 on the female side. The projection 341 of the contact 340 on the +x axis direction side has a projecting shape to mate with the contact 440. The other end of the contact 340 on the −x axis direction side is connected to a core wire 391 of the cable 390.

### Sleeve

The sleeve 350 includes a first part 351 in cylindrical shape and a second part 352 in cylindrical shape. The first part 351 is disposed inside the GND shell 310. The first part 351 covers a shield 393 that is exposed from an end of the outside cover 394 of the cable 390. The second part 352 covers the outside cover 394 of the cable 390. A connection part between the first part 351 and the second part 352 is thus located in close proximity to an end of the outside cover 394.

### Impedance Adjuster

As shown in FIG. 15, the impedance adjuster 360 has a part incorporated into the internal housing 330. To be specific, for example, a part of the impedance adjuster 360 on the +x axis direction side is incorporated into a part of the internal housing 330 on the −x axis direction side. The impedance adjuster 360 may be incorporated into the internal housing 330 by insert molding. Alternatively, the impedance adjuster 360 may be incorporated into the internal housing 330 by being press-fit into the internal housing 330.

The impedance adjuster 360 contains a conductor. For example, the impedance adjuster 360 contains a metal as a material. Note that the impedance adjuster 360 may contain a material other than a metal as long as it contains a conductor. The impedance adjuster 360 may be electrically isolated from the contact 340 and the core wire 391, which are a transmission path of a high-frequency signal, and may be electrically isolated from the ground potential. In other words, the impedance adjuster 360 may be a hollow ground potential that is not directly connected to another conductor. This eliminates the need for a circuit for connecting the impedance adjuster 360 to another conductor and reduces the impedance near a spatial layer 395 containing air in the relay connector device 30, thereby improving the impedance matching.

Note that the impedance adjuster 360 may be electrically connected to the ground potential. For example, the impedance adjuster 360 may be connected to the GND shell 310 so that the impedance adjuster 360 is held at electrically ground potential. This allows reducing the impedance near the spatial layer 395 containing air in the relay connector device 30, thereby improving the impedance matching.

The impedance adjuster 360 has a tube shape. For example, the impedance adjuster 360 has a cylindrical shape. The impedance adjuster 360 is disposed in such a way that its center axis is in the x axis direction. Thus, the impedance adjuster 360 has a tube shape with its center axis located at the contact 340 and the core wire 391 of the cable 390.

Note that the impedance adjuster 360 may have a square tube shape or may have a square tube shape whose corners are rounded as long as it has a tube shape. Further, the impedance adjuster 360 may have a tube shape where a plurality of members are combined into tube shape or may have a cut in a part of a tube shape. The impedance adjuster 360 adjusts the impedance by surrounding the contact 340 and the core wire 391 at the center axis, and thereby improves the impedance matching.

The impedance adjuster 360, together with the internal housing 330 and the contact 340, is disposed inside the GND shell 310. An end of the impedance adjuster 360 on the +x axis direction side is located inside the internal housing 330. An end of the impedance adjuster 360 on the −x axis direction side is located above a coating 392 of the cable 390. An end of the coating 392 on the +x axis direction side of the cable 390 is a cut surface. Thus, the impedance adjuster 360 covers the end of the coating 392. The impedance adjuster 360 thereby covers an exposed part of the core wire 391.

As described above, the impedance adjuster 360 covers an exposed part of the core wire 391 connected to the contact 340, which is exposed from the internal housing 330. The spatial layer 395 is formed between the exposed part of the core wire 391 connected to the contact 340, which is exposed from the internal housing 330, and the GND shell 310. The impedance adjuster 360 is disposed in the spatial layer 395 that is formed between the exposed part and the GND shell 310.

### EMI Shell

The EMI shell 370 contains a conductor. For example, the EMI shell 370 contains a metal as a material. Note that the EMI shell 370 may contain a material other than a metal as long as it contains a conductor. The EMI shell 370 has a semicylinder shape. The EMI shell 370 comes into contact with the GND shell 310 and covers a part of the GND shell 310. For example, the EMI shell 370 covers an opening of the GND shell 310.

### External Housing

An assembly of the GND shell 310, the internal housing 330, the contact 340, the sleeve 350, the impedance adjuster 360, and the EMI shell 370 is mounted inside the external housing 380.

### Cable

The cable 390 includes the core wire 391, the coating 392, the shield 393, and the outside cover 394. The structures and functions of the core wire 391, the coating 392, the shield 393, and the outside cover 394 in the cable 390 are the same as the structures and functions of the core wire 191, the coating 192, the shield 193, and the outside cover 194 in the cable 190, respectively.

### Female-Side Connector

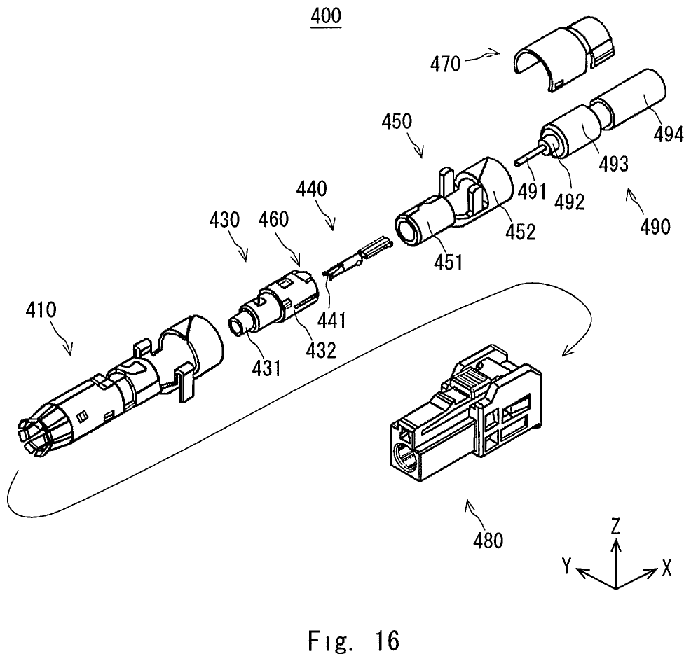

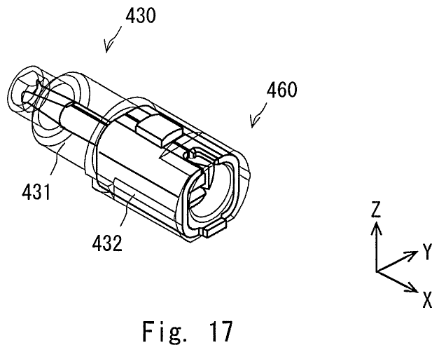

The connector 400 on the female side is described hereinafter. FIG. 16 is an exploded perspective view illustrating each member constituting the connector 400 in the relay connector device 30 according to the first embodiment. FIG. 17 is a perspective view illustrating an internal housing 430 and an impedance adjuster 460 in the relay connector device 30 according to the first embodiment. In FIG. 17, the internal housing 430 is shown transparent. As shown in FIG. 11, FIG. 13, and FIGS. 16 to 17, the connector 400 includes a GND shell 410, an internal housing 430, a contact 440, a sleeve 450, an impedance adjuster 460, an EMI shell 470, and an external housing 480.

In the case of the connector 300, the cable 390 is located on the −x axis direction side of the connector 300, whereas in the case of the connector 400, the cable 490 is located on the +x axis direction side of the connector 400. Otherwise, the basic structures and functions of the GND shell 410, the internal housing 430, the contact 440, the sleeve 450, the impedance adjuster 460, the EMI shell 470, and the external housing 480 of the connector 400 are the same as the structures and functions of the GND shell 310, the internal housing 330, the contact 340, the sleeve 350, the impedance adjuster 360, the EMI shell 370, and the external housing 380 of the connector 300, respectively.

### GND Shell

The internal housing 430, the contact 440, and the impedance adjuster 460 are disposed inside the GND shell 410. Further, the sleeve 450 and a part of the cable 490 are disposed inside the GND shell 410. The internal housing 430 may be press-fit to the inside of the GND shell 410.

An end of the GND shell 410 on the −x axis direction side is disposed in close proximity to an end of the internal housing 430 on the −x axis direction side. On the other hand, an end of the GND shell 410 on the +x axis direction side is located above an outside cover 494 of the cable 490. The position on the x axis of the end of the GND shell 410 on the +x axis direction side may coincide with that of an end of the sleeve 450 on the +x axis direction side.

### Internal Housing

As shown in FIG. 17, a part of the internal housing 430 on the +x axis direction side incorporates a part of the impedance adjuster 460 on the −x axis direction side. The internal housing 430 is disposed inside the GND shell 410. The contact 440 is disposed inside the internal housing 430. Thus, the internal housing 430 supports the contact 440.

The internal housing 430 includes a first part 431 and a second part 432. The first part 431 is disposed on the −x axis direction side of the second part 432. The first part 431 and the second part 432 have a cylindrical shape whose center axis coincides with the center axis of the internal housing 430. The outside diameter of the first part 431 is smaller than the outside diameter of the second part 432. The first part 431 mates with the recess 331 of the internal housing 330 of the connector 300. When the first part 431 mates with the recess 331, the projection 341 of the contact 340 of the connector 300 mates with a recess 441 of the contact 440 of the connector 400.

An end of the internal housing 430 on the −x axis direction side is an end surface of the first part 431 on the −x axis direction side. The end of the internal housing 430 on the −x axis direction side is disposed in close proximity to an end of the GND shell 410 on the −x axis direction side. For example, the position on the x axis of the end of the internal housing 430 on the −x axis direction side may coincide with that of the end of the GND shell 410 on the −x axis direction side. The recess 441 on the −x axis direction side of the contact 440 is disposed inside the first part 431.

An end of the internal housing 430 on the +x axis direction side is disposed in close proximity to an end of the contact 440 on the +x axis direction side. For example, the position on the x axis of the end of the internal housing 430 on the +x axis direction side may coincide with that of another end of the contact 440 on the +x axis direction side. A core wire 491 of the cable 490 is connected to the end of the contact 440 on the +x axis direction side. A connection part between the contact 440 and the core wire 491 of the cable 490 may be disposed inside the internal housing 430.

### Contact

The contact 440 has the recess 441 at one end on the −x axis direction side. The contact 440 is disposed inside the internal housing 430. An end of the contact 440 on the +x axis direction side is connected to the core wire 491 of the cable 490. The projection 341 of the contact 340 in the connector 300 on the male side mates with the recess 441 of the contact 440 in the connector 400 on the female side.

### Sleeve

The sleeve 450 includes a first part 451 in cylindrical shape and a second part 452 in cylindrical shape. The first part 451 is disposed on the −x axis direction side of the second part 452. The outside diameter of the first part 451 is smaller than the outside diameter of the second part 452. The inside diameter of the first part 451 is smaller than the inside diameter of the second part 452.

The first part 451 is disposed inside the GND shell 410. The first part 451 covers a shield 493 that is exposed from an end of the outside cover 494 of the cable 490. The second part 452 covers the outside cover 494 of the cable 490. A connection part between the first part 451 and the second part 452 is thus located in close proximity to an end of the outside cover 494.

### Impedance Adjuster

As shown in FIG. 17, the impedance adjuster 460 has a part incorporated into the internal housing 430. To be specific, for example, a part of the impedance adjuster 460 on the −x axis direction side is incorporated into a part of the internal housing 430 on the +x axis direction side.

The impedance adjuster 460, together with the internal housing 430 and the contact 440, is disposed inside the GND shell 410. An end of the impedance adjuster 460 on the −x axis direction side is located inside the internal housing 430. An end of the impedance adjuster 460 on the +x axis direction side is located above a coating 492 of the cable 490. An end of the coating 492 on the −x axis direction side of the cable 490 is a cut surface. Thus, the impedance adjuster 460 covers the end of the coating 492.

The impedance adjuster 460 covers an exposed part of the core wire 491 connected to the contact 440, which is exposed from the internal housing 430. A spatial layer 495 is formed between the exposed part of the core wire 491 connected to the contact 440, which is exposed from the internal housing 430, and the GND shell 410. The impedance adjuster 460 is disposed in the spatial layer 495 that is formed between the exposed part and the GND shell 410.

### EMI Shell

The EMI shell 470 comes into contact with the GND shell 410 and covers a part of the GND shell 410. For example, the EMI shell 470 covers an opening of the GND shell 410.

### External Housing

An assembly of the GND shell 410, the internal housing 430, the contact 440, the sleeve 450, the impedance adjuster 460, and the EMI shell 470 is mounted inside the external housing 480.

### Cable

The cable 490 includes the core wire 491, the coating 492, a shield 493, and the outside cover 494. The structures and functions of the core wire 491, the coating 492, the shield 493, and the outside cover 494 in the cable 490 are the same as the structures and functions of the core wire 391, the coating 392, the shield 393, and the outside cover 394 in the cable 390, respectively. Note that, however, the direction in which the core wire 491 connects to the contact 440, the direction of the end surface of the coating 492 having the cut surface, the direction of the end of the shield 493 and the direction in which it is folded, the direction of the end surface of the outside cover 494 and the like are opposite to those in the cable 390.

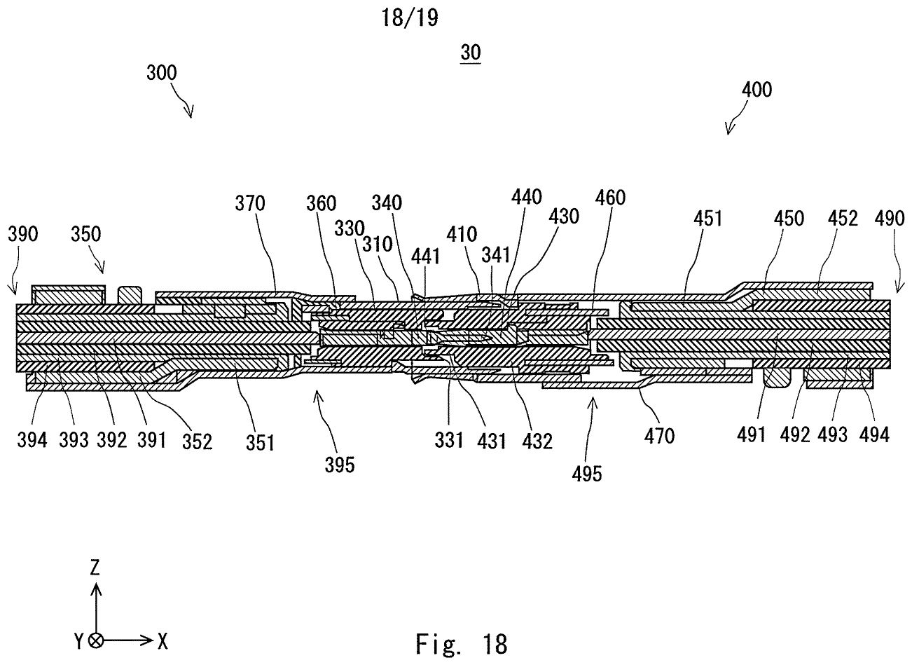

The operation of connection of the relay connector device 30 according to this embodiment is described hereinafter. FIG. 18 is a sectional view illustrating the operation of connecting the connectors 300 and 400 in the relay connector device 30 according to the first embodiment. As shown in FIGS. 11 and 18, in the relay connector device 30 according to this embodiment, the connector 300 and the connector 400 are opposed to each other. Then, the projection 341 of the contact 340 mates with the recess 441 of the contact 440. A transmission path of a high-frequency signal is thereby formed between the contact 340 and the contact 440. At the same time, the first part 431 of the internal housing 430 may mate with the recess 331 of the internal housing 330. Further, the GND shell 310 and the GND shell 410 come into contact with each other. A shield that covers the transmission path of a high-frequency signal is thereby formed.

The impedance adjuster 360 covers to surround the core wire 391 exposed from the internal housing 330 and the coating 392 in the spatial layer 395. Further, the impedance adjuster 460 covers to surround the core wire 491 exposed from the internal housing 430 and the coating 492 in the spatial layer 495.

An advantageous effect of this embodiment is described hereinafter. The relay connector device 30 according to this embodiment includes the impedance adjusters 360 and 460. The impedance adjuster 360 covers an exposed part of the core wire 391 connected to the contact 340, which is exposed from the internal housing 330. Thus, the impedance adjuster 360 allows adjusting the impedance of the relay connector device 30 and thereby improving the impedance matching. An advantageous effect of the impedance adjuster 460 is the same as that of the impedance adjuster 360, and the description thereof is omitted hereinbelow.

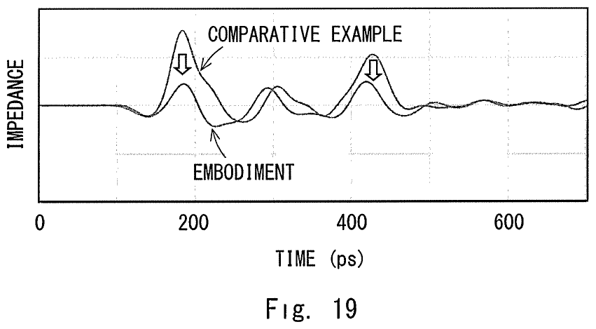

FIG. 19 is a graph illustrating the impedance in the relay connector device 30 according to the first embodiment, where the horizontal axis indicates time and the vertical axis indicates impedance. FIG. 19 also shows the impedance of the relay connector device 10 according to the comparative example. As shown in FIG. 19, the impedance of the relay connector device 30 according to this embodiment is lower than the impedance of the relay connector device 10 according to the comparative example, thus being improved.

Further, the impedance adjuster 360 is incorporated into the internal housing 330. This allows fixing the size and shape of the impedance adjuster 360 and thereby improves the stability of the impedance.

Further, the impedance adjuster 360 in the relay connector device 30 according to this embodiment is disposed in the spatial layer 395 that is formed between the exposed part of the core wire 391 and the GND shell 310. This allows controlling an increase in impedance in the core wire 391 of the cable 390 which is exposed in the spatial layer 395 containing air. This further improves the impedance matching.

The impedance adjuster 360 has a tube shape with its center axis located at the contact 340 and the core wire 391. This allows covering up the contact 340 and the core wire 391 in an isotropic manner and thereby equally adjusting the impedance.

The impedance adjuster 360 may be incorporated into the internal housing 330 by insert molding. This allows securely fixing the impedance adjuster 360 to the internal housing 330. On the other hand, the impedance adjuster 360 may be incorporated into the internal housing 330 by being press-fit into the internal housing 330. This allows easily incorporating the impedance adjuster 360 into the internal housing 330.

Although an embodiment of the present disclosure is described in the foregoing, the present disclosure involves appropriate modifications without impairment of its object and effects and is not restricted to the above-described embodiment. Further, the structures in the comparative example and the first embodiment may be appropriately combined.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A coaxial cable connector comprising a connector for relaying a cable, the connector comprising:
a contact containing a conductor;
an insulator body containing an insulator and supporting the contact; and
an impedance adjuster having a part incorporated into the insulator body and containing the conductor,
wherein the impedance adjuster covers an exposed part of a core wire of the cable connected to the contact, the exposed part being exposed from the insulator body.

2. The coaxial cable connector according to claim 1, wherein
the connector further comprises a GND shell containing the conductor,
the contact, the insulator body, and the impedance adjuster are disposed inside the GND shell, and
the impedance adjuster is disposed in a spatial layer formed between the exposed part and the GND shell.

3. The coaxial cable connector according to claim 2, wherein the impedance adjuster has a tube shape with a center axis located at the contact and the core wire.

4. The coaxial cable connector according to claim 3, wherein
the cable includes:
the core wire containing the conductor;
a coating having a part covering the core wire and containing the insulator;
a shield having a part covering the coating and containing the conductor; and
an outside cover having a part covering the shield and containing the insulator,
wherein the impedance adjuster covers an end of the coating.

5. The coaxial cable connector according to claim 1, wherein the impedance adjuster is incorporated into the insulator body by insert molding.

6. The coaxial cable connector according to claim 1, wherein the impedance adjuster is incorporated into the insulator body by being press-fit to the insulator body.

7. The coaxial cable connector according to claim 2, wherein the impedance adjuster is electrically connected to the GND shell.

8. The coaxial cable connector according to claim 2, wherein the impedance adjuster is electrically isolated from the GND shell, the contact, and the core wire.

9. A coaxial cable connector comprising a first connector and a second connector for relaying a first cable and a second cable, wherein
the first connector comprises:
a first contact containing a conductor and including a projection at one end;
a first insulator body containing an insulator and supporting the first contact; and
a first impedance adjuster having a part incorporated into the first insulator body and containing the conductor,
the first impedance adjuster covers an exposed part of a first core wire of the first cable connected to another end of the first contact, the exposed part being exposed from the first insulator body,
the second connector comprises:
a second contact containing the conductor and including a recess at one end;
a second insulator body containing the insulator and supporting the second contact; and
a second impedance adjuster having a part incorporated into the second insulator body and containing the conductor,
the second impedance adjuster covers an exposed part of a second core wire of the second cable connected to another end of the second contact, the exposed part being exposed from the second insulator body, and
the projection of the first contact mates with the recess of the second contact.
